(19) United States
(12) Patent Application Publication
(10) Pub. No.: US 2014/0082528 A1
(43) Pub. Date: Mar. 20, 2014

(54) METHOD AND SYSTEM FOR MOVING BOOKMARKS FOR A MOBILE BROWSER

(71) Applicant: TENCENT TECHNOLOGY (SHENZHEN) COMPANY LIMITED, Shenzhen (CN)

(72) Inventors: Xiaodan LIN, Shenzhen (CN); Sha MO, Shenzhen (CN)

(73) Assignee: TENCENT TECHNOLOGY (SHENZHEN) COMPANY LIMITED, Shenzhen (CN)

(21) Appl. No.: 14/089,289

(22) Filed: Nov. 25, 2013

Related U.S. Application Data
(63) Continuation of application No. PCT/CN2013/083322, filed on Sep. 11, 2013.

(30) Foreign Application Priority Data
Sep. 18, 2012 (CN) 201210346459.8

(51) Int. Cl. G06F 3/0482

(52) U.S. Cl. CPC G06F 3/0482
USPC 715/760

(57) ABSTRACT

A method is provided for moving bookmarks on a mobile terminal having a mobile browser. The method includes receiving a triggering instruction from a user of the mobile browser, triggering bookmark moving function on the mobile terminal, and prompting, on a bookmark page of the mobile browser, the user to select at least one target browser having bookmarks to be moved from a list of available browsers. The available browsers include at least a third-party browser. Further, the method includes determining the target browser selected by the user, and performing a bookmark operation to move the bookmarks of the target browser into the mobile browser of the user.

### CROSS-REFERENCES TO RELATED APPLICATIONS

This application is a continuation application of PCT Patent Application No. PCT/CN2013/083322, filed on Sep. 11, 2013, which claims priority of Chinese Patent Application No. 201210346459.8, filed on Sep. 18, 2012, the entire contents of all of which are incorporated by reference herein.

### FIELD OF THE INVENTION

The present invention generally relates to the Internet technologies and, more particularly, to a method and system for moving browser bookmarks for mobile terminals.

### BACKGROUND

With mobile browsers, because the bookmark facility is often attached to a particular browser, a mobile phone user may keep using a particular mobile browser due to the bookmarks. Even when the user needs to import bookmarks from another browser, mostly the user may just import bookmarks from a system browser or a PC browser, and is often unable to import bookmarks from other third-party browsers.

Currently, it is relatively easy to input bookmarks into the mobile browser from the system browser and the PC browser. However, when importing third-party browser bookmarks, a few issues may still exist.

First, the bookmark directory in a third-party browser may be not fixed. A third-party browser may change settings along changes in its version, including changes of the bookmark directory address.

Second, the third-party browser bookmark folder may be encrypted. Encryption may increase the difficulty of breaking the encryption, and the encryption format of the third-party browser may change in subsequent new versions, such as new encryption keys, thereby greatly increasing the cost for the user to switch browsers.

The disclosed method and system are directed to solve one or more problems set forth above and other problems.

### BRIEF SUMMARY OF THE DISCLOSURE

One aspect of the present disclosure includes a method for moving bookmarks on a mobile terminal having a mobile browser. The method includes receiving a triggering instruction from a user of the mobile browser, triggering bookmark moving function on the mobile terminal and prompting, on a bookmark page of the mobile browser, the user to select at least one target browser having bookmarks to be moved from a list of available browsers. The available browsers include at least a third-party browser. Further, the method includes determining the target browser selected by the user, and performing a bookmark operation to move the bookmarks of the target browser into the mobile browser of the user.

Another aspect of the present disclosure includes a mobile terminal having a mobile browser. The mobile terminal includes a trigger module, a selection module, and a moving module. The trigger module is configured to receive a triggering instruction from a user of the mobile browser, and to trigger bookmark moving function on the mobile terminal. The selection module is configured to prompt, on a bookmark page of the mobile browser, the user to select at least one target browser having bookmarks to be moved from a list of available browsers, and to determine the target browser selected by the user. The available browsers include at least a third-party browser. Further, the moving module is configured to perform a bookmark operation to move the bookmarks of the target browser into the mobile browser of the user.

Another aspect of the present disclosure includes a non-transitory computer-readable medium having computer program. When being executed by a processor, the computer program performs a method for moving bookmarks on a mobile terminal having a mobile browser. The method includes receiving a triggering instruction from a user of the mobile browser, triggering bookmark moving function on the mobile terminal and prompting, on a bookmark page of the mobile browser, the user to select at least one target browser having bookmarks to be moved from a list of available browsers. The available browsers include at least a third-party browser. Further, the method includes determining the target browser selected by the user, and performing a bookmark operation to move the bookmarks of the target browser into the mobile browser of the user.

Other aspects of the present disclosure can be understood by those skilled in the art in light of the description, the claims, and the drawings of the present disclosure.

### BRIEF DESCRIPTION OF THE DRAWINGS

FIG. 1 illustrates a flow diagram of an exemplary bookmark moving process consistent with the disclosed embodiments;

FIGS. 2A-2C illustrates user interfaces of an exemplary bookmark moving process consistent with the disclosed embodiments;

FIG. 3 illustrates a flow diagram of an exemplary bookmark moving operation consistent with the disclosed embodiments;

FIG. 4 illustrates a block diagram of an exemplary bookmark moving system consistent with the disclosed embodiments;

FIG. 5 illustrates a block diagram of an exemplary bookmark moving module consistent with the disclosed embodiments;

FIG. 6 illustrates an exemplary operating environment incorporating certain disclosed embodiments; and

FIG. 7 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

A user may use different mobile browsers from time to time. When using a new browser, the user may also want to move or import bookmarks from other browsers or other devices to the new mobile browser. There may be various types of browsers for moving the bookmarks. For example, the user may move bookmarks from a system browser, a PC-side browser, and a third-party browser, etc. A system browser may refer to a browser provided by the mobile device maker, which may be a standard default browser used on the mobile terminal. A PC-side browser may refer to a browser used by the user on a personal computer (PC), such as a QQ Bookmark or QQ browser, which is a PC program used by the user and not a mobile browser. The PC browser may communicate with a server that allow the user to store and retrieve bookmarks via network. Further, a third-party browser may refer to any other type of browser (e.g., mobile browsers) that supports online bookmark functionality.

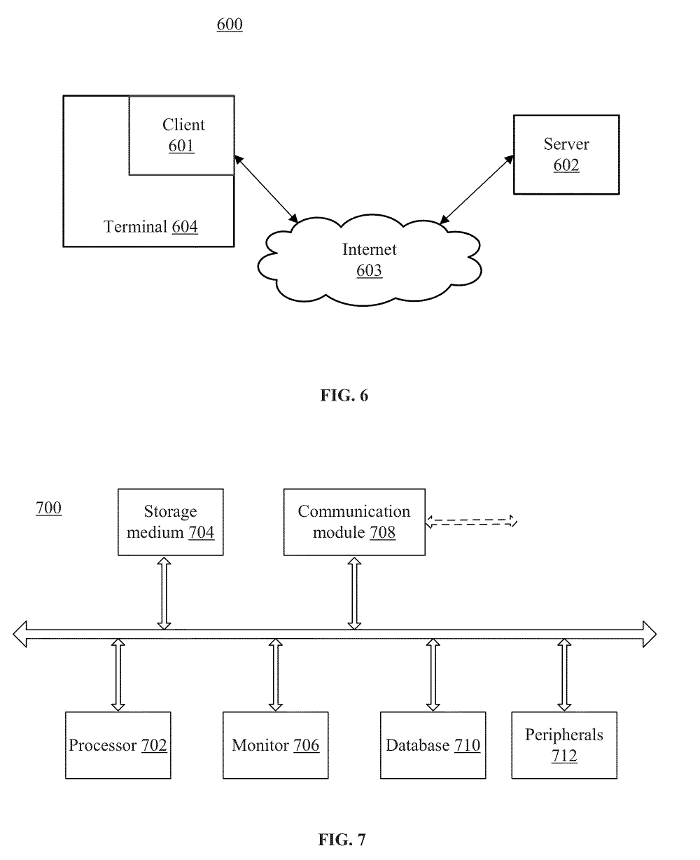

FIG. 6 illustrates an exemplary operating environment 600 incorporating certain disclosed embodiments. As shown in FIG. 6, environment 600 may include a terminal 604, the Internet 603, and a server 602. The Internet 603 may include any appropriate type of communication network for providing network connections to the terminal 604 and the server 602. For example, Internet 603 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The server 602 may include any appropriate server computers configured to provide certain server functionalities, such as a web server functionality, a QQ server functionality, and/or a third-party browser server functionality for responding a user's request for web browsing operations including moving or importing bookmarks, etc., or other application server. Although only one server is shown, any number of servers can be included. The server 602 may be operated in a cloud or non-cloud computing environment.

Terminal 604 may include any appropriate type of mobile computing devices, such as mobile phones, smart phones, tablets, notebook computers, or any type of computing platform. Terminal 604 may include one or more clients 601. The client 601, as used herein, may include any appropriate mobile application software, hardware, or a combination of application software and hardware to achieve certain client functionalities. For example, client 601 may include a mobile browser. According to actual needs in different terminals, a mobile client may be a browser installed on the terminal for browsing, including various types of existing and future browser installed on terminals. Although only one client 601 is shown in the environment 600, any number of clients 601 may be included.

Terminal 604 and/or server 602 may be implemented on any appropriate computing platform. FIG. 7 illustrates a block diagram of an exemplary computer system 700 capable of implementing terminal 604 and/or server 602.

As shown in FIG. 7, computer system 700 may include a processor 702, a storage medium 704, a monitor 706, a communication module 708, a database 710, and peripherals 712. Certain devices may be omitted and other devices may be included.

Processor 702 may include any appropriate processor or processors. Further, processor 702 can include multiple cores for multi-thread or parallel processing. Storage medium 704 may include memory modules, such as Read-only memory (ROM), Random Access Memory (RAM), flash memory modules, and erasable and rewritable memory, and mass storages, such as CD-ROM, U-disk, and hard disk, etc. Storage medium 704 may store computer programs for implementing various processes, when executed by processor 702.

Further, peripherals 712 may include I/O devices such as keyboard and mouse, and communication module 708 may include network devices for establishing connections through the communication network. Database 710 may include one or more databases for storing certain data and for performing certain operations on the stored data, such as database searching.

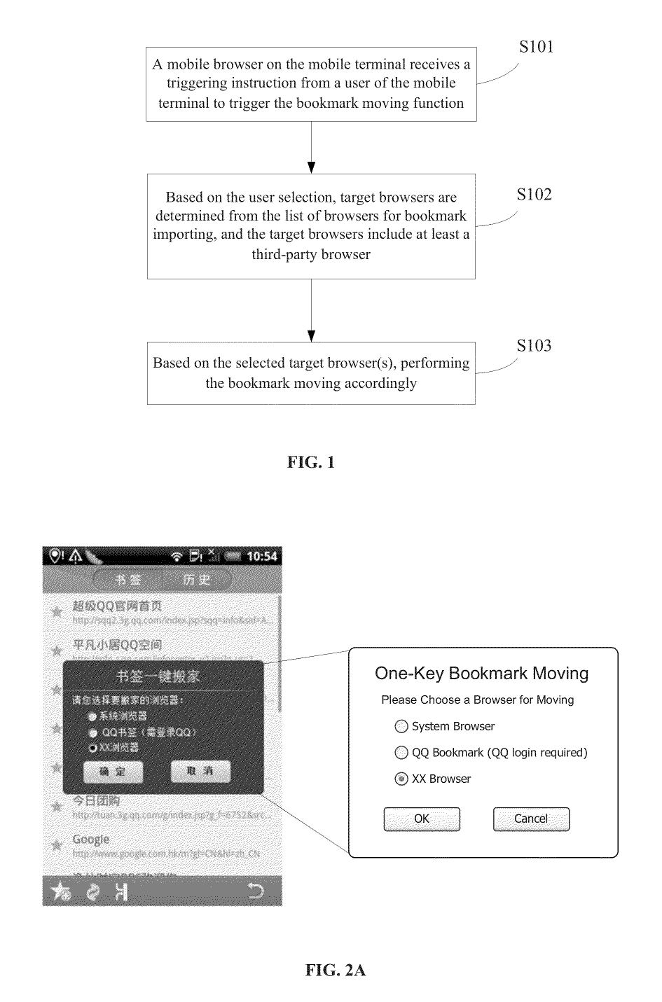

In operation, terminals/clients and/or servers 602 may provide a mobile browser bookmark moving service to a user of the terminal. FIG. 1 illustrates a flow diagram of an exemplary bookmark moving process consistent with the disclosed embodiments.

As shown in FIG. 1, the bookmark moving process may include the following steps.

Step S101, a mobile browser on the mobile terminal receives a triggering instruction from a user of the mobile terminal to trigger the bookmark moving function.

The mobile browser on the mobile terminal is provided with a browser bookmark moving function. For example, the bookmark moving function may be implemented on the bookmark page of the mobile browser and may be accessible through a user interface, such as a button or a command. The user may select a “bookmark moving” button on the bookmark page of the mobile browser to trigger the bookmark moving function.

After being triggered, the bookmark moving function is configured to prompt the user to select at least one target browser (i.e., the browser providing bookmarks to be moved) from a list of browsers available. The user may select one or more target browsers to import the bookmarks from the target browsers into the mobile browser currently used by the user (i.e., the destination browser).

Step S102, based on the user selection, target browsers are determined from the list of browsers for bookmark importing, and the target browsers include at least a third-party browser.

The system browser may have a fixed path for the browser bookmark folder (i.e., the path of the system browser bookmark folder does not change). Further, the system browser's bookmark folder in general is not encrypted. The mobile browser (e.g., the bookmark moving function) can import all bookmarks in the system browser's bookmark folder to the mobile browser according to the path of the system browser's bookmark folder.

To import bookmarks from a PC-side browser, the mobile browser needs a user name and password to import the bookmarks of the PC-side browser. However, for third party browser bookmarks, different approaches may be needed because the third party browsers may have different bookmark folders and the bookmark folders may be encrypted.

That is, while it may be easy to import bookmarks from the system browser or a PC-side browser, importing bookmarks from a third-party browser may be difficult. The bookmark directory in a third-party browser may be not fixed. A third-party browser may change setting along changes in its version, including changes of the bookmark directory address. Further, a third-party browser bookmark folder may be encrypted. Encryption may increase the difficulty of breaking the encryption, and the encryption format of the third-party browser may change in subsequent new versions, such as new encryption keys, thereby greatly increasing the cost for the user to switch browsers.

To obtain the content of the online bookmarks from a third party browser, a bookmark extraction mechanism may need to be used, such as a web crawler technology or similar technology based bookmark extraction method.

According to the web crawler technology, a web crawler is also known as a web spider, which can automatically extract webpage programs according to certain rules, as well as automatically exact Internet webpages through the network. Web crawler technology is generally used to check whether all links on a website are valid, or is used to save relevant data of webpages for a search engine. Search engines often use web crawlers to find web contents. Because HTML documents on the network using hyperlinks to be connected together, as if they are woven into a web, and the web crawler crawls along this web. Whenever reaching a webpage, the web crawler obtains the webpage using a crawling program, and extracts contents from the webpage. Further, the web crawler extracts hyperlinks as clues for further crawling.

Step S103, based on the selected target browser(s), performing the bookmark moving accordingly.

Specifically, after the user triggers the bookmark moving operation, the user selects the target browser(s). If the user selects to import bookmarks from the system browser, the mobile browser starts the moving action, which obtains the path of the bookmark folder of the system browser and imports all bookmarks into the mobile browser.

If the user selects to import bookmarks from the PC-side browser, the mobile browser pops up a login window. After the user successfully logs in, the bookmark moving operation can be performed. Further, if the user selects to import bookmarks from the third-party browser, the mobile terminal links to the third-party browser's account login page. After the user enters account number and password and successful logs in, the online bookmarks of the third-party browser can be displayed to the user. Based on the crawler technology, the third-party web browser bookmarks are crawled down, and then be imported into the mobile browser, thereby achieving a third-party browser bookmark moving operation.

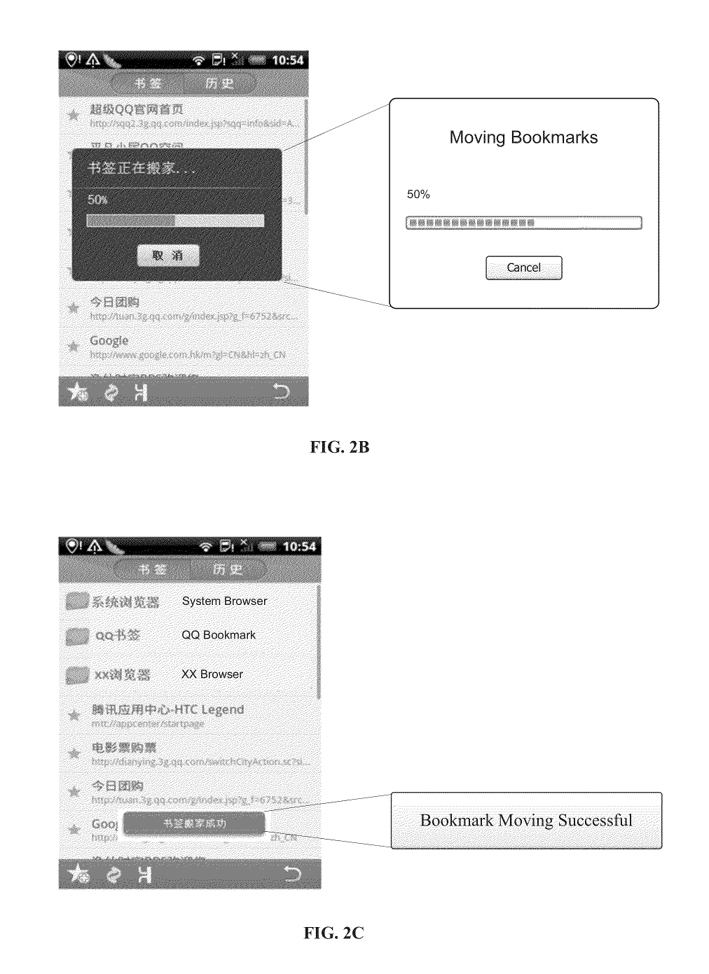

FIGS. 2A, 2B, and 2C illustrate an exemplary bookmark importation process for third-party browsers. As shown in FIG. 2A, after the user triggers the bookmark moving function, the mobile browser prompts the user with available preset target browsers for bookmark moving operation (i.e., the browsers with bookmarks to be imported into the mobile terminal) as optional selection choices. The selections include the system browser, the QQ Bookmark (PC-side browser), and the XX browser (e.g., a third-party browser).

The users can choose whether the bookmarks to be moved are the system browser bookmarks, QQ bookmarks, and/or XX browser bookmarks.

The user may select the XX browser options, shown in FIG. 2A, and may click on the “OK” button on the prompt window over the bookmark page. The mobile browser establishes a link to the account homepage of the XX browser. The user then enters account number and password, and successfully logs in such that the online bookmarks in the XX browsers can be displayed to the user. Further, using the crawler, the online bookmarks can be crawled down and imported into the local mobile browser on the mobile terminal.

At this time, as shown in FIG. 2B, the mobile browser also displays a status bar and a percentage to reflecting the bookmark moving progress. When the moving operation completes, the mobile browser may display a bookmark moving successful message, shown in FIG. 2C.

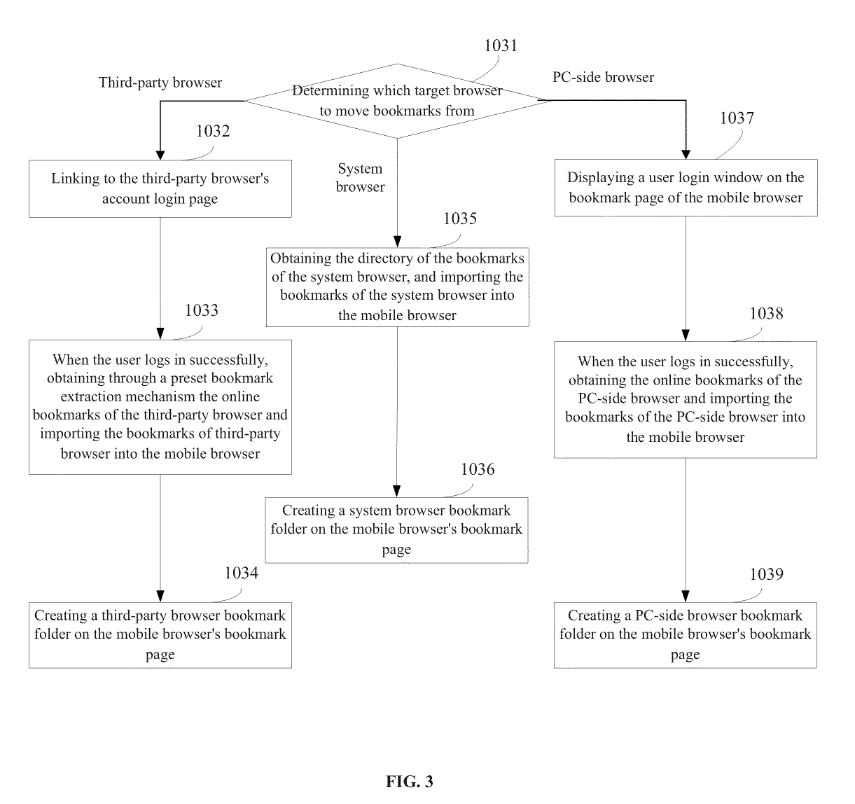

Thus, more particularly, Step 103 above may include the following steps, as shown in FIG. 3.

Step S1031, determining the option selected by the user as to which target browser to move bookmarks from. When it is determined that the selected target browser is the third-party browser, the process goes to Step S1032; when it is determined that the selected target browser is the system browser, the process goes to Step S1035; and when it is determined that the selected target browser is the PC-side browser, the process goes to Step S1037.

Step S1032, linking to the third-party browser's account login page.

Step S1033, when the user logs in successfully, obtaining through a preset bookmark extraction mechanism the online bookmarks of the third-party browser and importing the bookmarks of third-party browser into the mobile browser. The preset bookmark extraction mechanism includes at least a crawling method using a web crawler.

Step S1034, creating a third-party browser bookmark folder on the mobile browser's bookmark page.

Step S1035, obtaining the directory (or path) of the bookmarks of the system browser, and importing the bookmarks of the system browser into the mobile browser.

Step S1036, creating a system browser bookmark folder on the mobile browser's bookmark page.

Step S1037, displaying a user login window on the bookmark page of the mobile browser.

Step S1038, when the user logs in successfully, obtaining the online bookmarks of the PC-side browser and importing the bookmarks of the PC-side browser into the mobile browser.

Step S1039, creating a PC-side browser bookmark folder on the mobile browser's bookmark page.

As shown in FIG. 2C, the system browser bookmark folder, the PC-side browser bookmark folder, and the third-party browser bookmark folder are created on the bookmark page of the mobile browser, after the bookmark moving operation is performed successfully for the system browser, the PC-side browser, and the third-party browser.

Thus, the bookmark moving function can be achieved for importing bookmarks from the system browser, the PC-side browser, and the third-party browser, ensuring the integrity of bookmarks used by the user and greatly reducing the cost for the user cost to switch browsers.

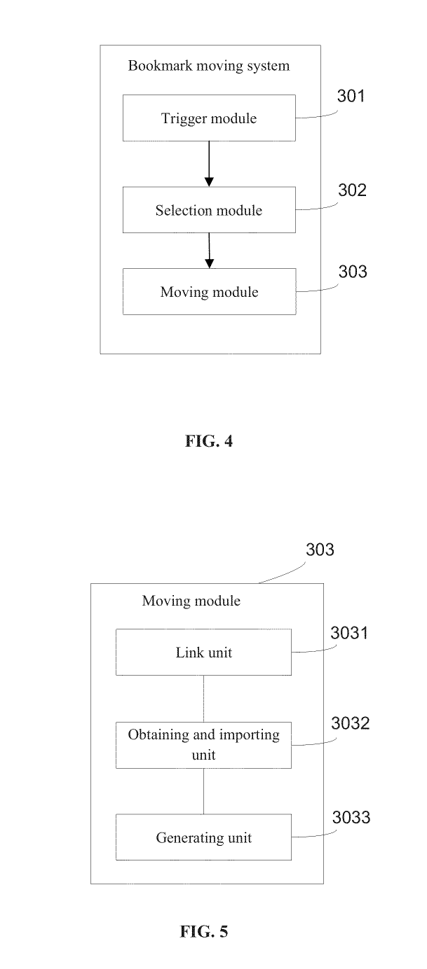

FIG. 4 illustrates an exemplary bookmark moving system consistent with the disclosed embodiments. As shown in FIG. 4, the bookmark moving system includes a trigger module 301, a selection module 302, and a moving module 303.

The trigger module 301 may be used in the mobile browser for receiving a triggering instruction from the user to trigger the bookmark moving function. The select module 302 is configured to determine, based on the user selection, a target browser from a list of browsers for bookmark importing, and the target browsers include at least a third-party browser. Further, the moving module 303 is provided to perform the bookmark moving operation based on the target browser(s) selected by the user.

That is, the bookmark moving function is provided in the mobile browser for the user on the mobile terminal. When the user selects a “bookmark moving” button on the bookmark page of the mobile browser, the trigger module 301 is triggered to trigger the bookmark moving function. After being triggered, the bookmark moving function is configured to prompt the user to select at least one target browser (i.e., the browser providing bookmarks to be moved) from a list of browsers available. The user may select a target browser to import the bookmarks from the target browsers into the mobile browser currently used by the user (i.e., the destination browser).

The selection module 302 selects a target browser for bookmark importing based on the user's selection of the browser selection options, and the selection of target browsers include at least a third-party browser. Thus, bookmarks on the target browsers (e.g., the system browser, the PC-side browser, and the third-party browser) can be easily moved into the user's mobile terminal, in particular the third-party browser bookmarks, reducing the cost for the user to switch mobile browsers.

As previously described, while it may be relatively easy to import bookmarks from the system browser or a PC-side browser, importing bookmarks from a third-party browser may be difficult. The bookmark directory in a third-party browser may be not fixed. A third-party browser may change setting along changes in its version, including changes of the bookmark directory address. Further, a third-party browser bookmark folder may be encrypted. Encryption may increase the difficulty of breaking the encryption, and the encryption format of the third-party browser may change in subsequent new versions, such as new encryption keys, thereby greatly increasing the cost for the user to switch browsers.

To obtain the content of the online bookmarks from a third-party browser, the bookmark moving system uses a bookmark extraction mechanism, such as a web crawler technology or similar technology based bookmark extraction method, to obtain bookmarks from the third-party browser.

According to the web crawler technology, a web crawler is also known as a web spider, which can automatically extract webpage programs according to certain rules, as well as automatically exact Internet webpages through the network. Web crawler technology is generally used to check whether all links on a website are valid, or is used to save relevant data of webpages for a search engine. Search engines often use web crawlers to find web contents. Because HTML documents on the network using hyperlinks to be connected together, as if they are woven into a web, and the web crawler crawls along this web. Whenever reaching a webpage, the web crawler obtains the webpage using a crawling program, and extracts contents from the webpage. Further, the web crawler extracts hyperlinks as clues for further crawling.

More specifically, after the user triggers the bookmark moving operation, and selects the target browser for moving the bookmarks, the moving module 303 performs the moving operation according to the target browser selected by the user.

If the user selects to import bookmarks from the system browser, the moving module 303 starts the moving action, which obtains the path of the bookmark folder of the system browser and imports all bookmarks into the mobile browser.

If the user selects to import bookmarks from the PC-side browser, the moving module 303 pops up a login window. After the user successfully logs in, the bookmark moving operation can be performed. Further, if the user selects to import bookmarks from the third-party browser, the moving module 303 links to the third-party browser's account login page. After the user enters account number and password and successful logs in, the online bookmarks of the third-party browser can be displayed to the user. Based on the crawler technology, the third-party web browser bookmarks are crawled down, and then be imported into the mobile browser, thereby achieving a third-party browser bookmark moving operation.

Particularly, as shown in FIG. 5, to perform the above bookmark moving functions, the moving module 303 may include a link unit 3031, an obtaining and importing unit 3032, and a generating unit 3033.

The link unit 3031 is provided for, when the selection module 302 selects the third-party browser for bookmarks importing, establishing a link between the user's mobile browser and the third-party browser's account login page.

The obtaining and importing unit 3032 is provided for, when the user logs in successfully, obtaining the online bookmarks for the third-party browser by a preset extraction mechanism and importing the bookmarks into the user's mobile browser. The preset extraction mechanism includes at least a crawling method based on web crawlers.

The generating unit 3033 is provided for creating a third-party browser bookmark folder on the mobile browser's bookmark page.

The obtaining and importing unit 3032 may also be configured to obtain the directory (or path) of the bookmarks of the system browser, and to import the bookmarks of the system browser into the mobile browser. The generating unit 3033 may also be configured to create a system browser bookmark folder on the mobile browser's bookmark page.

Further, the link unit 3031 may also be configured to display a user login window on the bookmark page of the mobile browser, and the obtaining and importing unit 3032 may also be configured to, when the user logs in successfully, obtain the online bookmarks of the PC-side browser and to import the bookmarks of the PC-side browser into the mobile browser. The generating unit 3033 may also be configured to create a PC-side browser bookmark folder on the mobile browser's bookmark page.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various Internet browser based applications may be implemented. For example, the bookmark moving function can be achieved for importing bookmarks from the system browser, the PC-side browser, and the third-party browser, ensuring the integrity of bookmarks used by the user and greatly reducing the cost for the user cost to switch browsers.

What is claimed is:

1. A method for moving bookmarks on a mobile terminal having a mobile browser, comprising:
receiving a triggering instruction from a user of the mobile browser;
triggering bookmark moving function on the mobile terminal;
prompting, on a bookmark page of the mobile browser, the user to select at least one target browser having bookmarks to be moved from a list of available browsers, wherein the available browsers includes at least a third-party browser;
determining the target browser selected by the user; and
performing a bookmark operation to move the bookmarks of the target browser into the mobile browser of the user.

2. The method according to claim 1, wherein performing a bookmark operation further includes:
when the target browser selected by the user is the third-party browser, linking to an account login page of the third-party browser;
when the user successful logs in the account, obtaining online bookmarks of the third-party browser using a preset bookmark extraction mechanism;
importing the online bookmarks of the third-party browser into the mobile browser; and
creating a third-party browser bookmark folder on the bookmark page of the mobile browser.

3. The method according to claim 2, wherein:
the preset bookmark extraction mechanism is a crawling method using a web crawler.

4. The method according to claim 1, wherein:
the available browsers include a system browser, a PC-side browser, and the third-party browser; and
the available browsers are prompted to the user by an option list on the bookmark page of the mobile browser.

5. The method according to claim 1, wherein:
when the target browser selected by the user is the system browser, obtaining a directory of the bookmarks of the system browser;
importing the bookmarks of the system browser into the mobile browser; and
creating a system browser bookmark folder on the bookmark page of the mobile browser.

6. The method according to claim 1, wherein:
when the target browser selected by the user is the PC-side browser, displaying a user login window on the bookmark page of the mobile browser;
when the user logs in the user login window successfully, obtaining online bookmarks of the PC-side browser displayed to the user;
importing the bookmarks of the PC-side browser into the mobile browser; and
creating a PC-side browser bookmark folder on the bookmark page of mobile browser.

7. A mobile terminal having a mobile browser, comprising:
a trigger module configured to receive a triggering instruction from a user of the mobile browser, and to trigger bookmark moving function on the mobile terminal;
a selection module configured to prompt, on a bookmark page of the mobile browser, the user to select at least one target browser having bookmarks to be moved from a list of available browsers, and to determine the target browser selected by the user, wherein the available browsers includes at least a third-party browser; and
a moving module configured to perform a bookmark operation to move the bookmarks of the target browser into the mobile browser of the user.

8. The mobile terminal according to claim 7, wherein, to perform a bookmark operation, the moving module is further configured to:
when the target browser selected by the user is the third-party browser, link to an account login page of the third-party browser;
when the user successful logs in the account, obtain online bookmarks of the third-party browser using a preset bookmark extraction mechanism;
import the online bookmarks of the third-party browser into the mobile browser; and
create a third-party browser bookmark folder on the bookmark page of the mobile browser.

9. The mobile terminal according to claim 8, wherein:
the preset bookmark extraction mechanism is a crawling method using a web crawler.

10. The mobile terminal according to claim 7, wherein:
the available browsers include a system browser, a PC-side browser, and the third-party browser; and
the available browsers are prompted to the user via an option list on the bookmark page of the mobile browser.

11. The mobile terminal according to claim 7, wherein the moving module is configured to:
when the target browser selected by the user is the system browser, obtain a directory of the bookmarks of the system browser;
import the bookmarks of the system browser into the mobile browser; and
create a system browser bookmark folder on the bookmark page of the mobile browser.

12. The mobile terminal according to claim 7, wherein the moving module is configured to:
when the target browser selected by the user is the PC-side browser, display a user login window on the bookmark page of the mobile browser;
when the user logs in the user login window successfully, obtain online bookmarks of the PC-side browser displayed to the user;
import the bookmarks of the PC-side browser into the mobile browser; and
create a PC-side browser bookmark folder on the bookmark page of mobile browser.

13. A non-transitory computer-readable medium having computer program for, when being executed by a processor, performing a method for moving bookmarks on a mobile terminal having a mobile browser, comprising:
receiving a triggering instruction from a user of the mobile browser;
triggering bookmark moving function on the mobile terminal;
prompting, on a bookmark page of the mobile browser, the user to select at least one target browser having bookmarks to be moved from a list of available browsers, wherein the available browsers includes at least a third-party browser;
determining the target browser selected by the user; and
performing a bookmark operation to move the bookmarks of the target browser into the mobile browser of the user.

14. The computer-readable medium according to claim 13, wherein performing a bookmark operation further includes:
when the target browser selected by the user is the third-party browser, linking to an account login page of the third-party browser;
when the user successful logs in the account, obtaining online bookmarks of the third-party browser using a preset bookmark extraction mechanism;
importing the online bookmarks of the third-party browser into the mobile browser; and
creating a third-party browser bookmark folder on the bookmark page of the mobile browser.

15. The computer-readable medium according to claim 14, wherein:
the preset bookmark extraction mechanism is a crawling method using a web crawler.

16. The computer-readable medium according to claim 13, wherein:
the available browsers include a system browser, a PC-side browser, and the third-party browser; and
the available browsers are prompted to the user by an option list on the bookmark page of the mobile browser.

17. The computer-readable medium according to claim 13, wherein:
when the target browser selected by the user is the system browser, obtaining a directory of the bookmarks of the system browser;
importing the bookmarks of the system browser into the mobile browser; and
creating a system browser bookmark folder on the bookmark page of the mobile browser.

18. The computer-readable medium according to claim 13, wherein:
when the target browser selected by the user is the PC-side browser, displaying a user login window on the bookmark page of the mobile browser;
when the user logs in the user login window successfully, obtaining online bookmarks of the PC-side browser displayed to the user;
importing the bookmarks of the PC-side browser into the mobile browser; and
creating a PC-side browser bookmark folder on the bookmark page of mobile browser.
